(19) United States
(12) Patent Application Publication
(10) Pub. No.: US 2026/0112245 A1
(43) Pub. Date: Apr. 23, 2026

(54) SYSTEMS AND METHODS FOR USING LONG-TERM NETWORK STORAGE TO GENERATE IMPROVED LANGUAGE MODEL CONTEXT

(71) Applicant: DK Crown Holdings Inc., Boston, MA (US)

(72) Inventors: Robin Mohseni, Billericay (GB); Gengyuan Zhang, Boston, MA (US)

(73) Assignee: DK Crown Holdings Inc., Boston, MA (US)

(21) Appl. No.: 19/360,597

(22) Filed: Oct. 16, 2025

Related U.S. Application Data
(60) Provisional application No. 63/708,554, filed on Oct. 17, 2024.
(60) Provisional application No. 63/708,492, filed on Oct. 17, 2024.
(60) Provisional application No. 63/708,504, filed on Oct. 17, 2024.
(60) Provisional application No. 63/708,528, filed on Oct. 17, 2024.
(60) Provisional application No. 63/708,509, filed on Oct. 17, 2024.
(60) Provisional application No. 63/708,542, filed on Oct. 17, 2024.
(60) Provisional application No. 63/711,415, filed on Oct. 24, 2024.
(60) Provisional application No. 63/719,406, filed on Nov. 12, 2024.
(60) Provisional application No. 63/741,297, filed on Jan. 2, 2025.
(60) Provisional application No. 63/741,671, filed on Jan. 3, 2025.

(51) Int. Cl. G07F 17/32; G06F 40/295

(52) U.S. Cl. CPC G07F 17/3237; G06F 40/295

(57) ABSTRACT

Systems and methods for using long-term network storage to generate improved language model context are disclosed. A system can maintain player profiles comprising a data structure identifying a plurality of player attributes. The system can maintain wager opportunities corresponding to live events. The system can extract from communication sessions identifying a first player profile, text data satisfying one or more extraction criteria. The system can update the player attributes of the first player profile using the text data. The system can receive from a client device associated with the first player profile, a prompt comprising a request for a wager recommendation. The system can generate, using a language model and the prompt, an output message identifying a wager opportunity selected based on the plurality of player attributes of the first player profile. The system can provide the output message to the client device in response to the request.

### CROSS-REFERENCES TO RELATED APPLICATIONS

This application claims the benefit of and priority to U.S. Provisional Patent Application No. 63/741,297, filed Jan. 2, 2025; and claims the benefit of and priority to U.S. Provisional Patent Application No. 63/708,509, filed Oct. 17, 2024; and claims the benefit of and priority to U.S. Provisional Patent Application No. 63/708,492, filed Oct. 17, 2024; and claims the benefit of and priority to U.S. Provisional Patent Application No. 63/708,528, filed Oct. 17, 2024; and claims the benefit of and priority to U.S. Provisional Patent Application No. 63/708,542, filed Oct. 17, 2024; and claims the benefit of and priority to U.S. Provisional Patent Application No. 63/708,504, filed Oct. 17, 2024; and claims the benefit of and priority to U.S. Provisional Patent Application No. 63/711,415, filed Oct. 24, 2024; and claims the benefit of and priority to U.S. Provisional Patent Application No. 63/708,554, filed Oct. 17, 2024; and claims the benefit of and priority to U.S. Provisional Patent Application No. 63/719,406, filed Nov. 12, 2024; and claims the benefit of and priority to U.S. Provisional Patent Application No. 63/741,671, filed Jan. 3, 2025; the contents of each of which are incorporated herein by reference in their entireties for all purposes.

### BACKGROUND

Network environments can support communication between multiple computing devices using techniques such as packet-switching. Data transmitted between devices can be synchronized such that multiple devices on the same network access the same information. However, it can be challenging to efficiently synchronize data transmission for graphical elements using conventional networking technology.

### SUMMARY

At least one other aspect of the present disclosure is directed to a system. The system can include one or more processors coupled to a non-transitory memory. The system can maintain a plurality of player profiles. Each player profile of the plurality of player profiles can include a data structure identifying a plurality of player attributes. The system can maintain a plurality of wager opportunities corresponding to a plurality of live events. The system can extract, from a plurality of communication sessions identifying a first player profile of the plurality of player profiles, text data satisfying one or more extraction criteria. The system can update the plurality of player attributes of the first player profile using the text data. The system can receive, from a client device associated with the first player profile, a prompt comprising a request for a wager recommendation. The system can generate, using a language model and the prompt, an output message identifying at least one wager opportunity of the plurality of wager opportunities selected based on the plurality of player attributes of the first player profile. The system can provide the output message to the client device in response to the request.

In some implementations, the system can preprocess the text data to remove one or more words, phrases, or symbols. The system can extract one or more keywords from the text data extracted from the plurality of communication sessions. The system can update the plurality of player attributes of the first player profile based on the one or more keywords. The system can determine a semantic score for the one or more keywords. The system can update the plurality of player attributes of the first player profile based on the semantic score determined for each the one or more keywords.

In some implementations, the system can extract the one or more keywords from the text data based on a named-entity recognition process. The system can generate an input context for the language model using the plurality of player attributes, the prompt, and the at least one wager opportunity. The system can select the at least one wager opportunity based on a similarity between data of the at least one wager opportunity and the plurality of player attributes. The plurality of player attributes can include an indication of a wager type of a plurality of wager types. The plurality of player attributes can include an indication of one or more participants or one or more teams corresponding to one or more live events. The plurality of player attributes can include an indication of one or more types of live events.

At least one aspect of the present disclosure relates to a method. The method can be performed, for example, by one or more processors coupled to a non-transitory memory. The method can include maintaining, by one or more processors coupled to non-transitory memory, a plurality of player profiles. Each player profile of the plurality of player profiles can include a data structure identifying a plurality of player attributes. The method can include maintaining a plurality of wager opportunities corresponding to a plurality of live events. The method can include extracting, from a plurality of communication sessions identifying a first player profile of the plurality of player profiles, text data satisfying one or more extraction criteria. The method can include updating, the plurality of player attributes of the first player profile using the text data. The method can include receiving, from a client device associated with the first player profile, a prompt comprising a request for a wager recommendation. The method can include generating, using a language model and the prompt, an output message identifying at least one wager opportunity of the plurality of wager opportunities selected based on the plurality of player attributes of the first player profile. The method can include providing the output message to the client device in response to the request.

In some implementations, the method can include preprocessing the text data to remove one or more words, phrases, or symbols. The method can include extracting one or more keywords from the text data extracted from the plurality of communication sessions. The method can include updating the plurality of player attributes of the first player profile based on the one or more keywords. The method can include determining a semantic score for the one or more keywords. The method can include updating the plurality of player attributes of the first player profile based on the semantic score determined for each the one or more keywords. The method can include extracting the one or more keywords from the text data based on a named-entity recognition process.

In some implementations, the method can include generating an input context for the language model using the plurality of player attributes, the prompt, and the at least one wager opportunity. The method can include selecting the at least one wager opportunity based on a similarity between data of the at least one wager opportunity and the plurality of player attributes. The plurality of player attributes can include an indication of a wager type of a plurality of wager types. The plurality of player attributes can include an indication of one or more participants or one or more teams corresponding to one or more live events. The plurality of player attributes can include an indication of one or more types of live events.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations and are incorporated into and constitute a part of this specification. Aspects can be combined, and it will be readily appreciated that features described in the context of one aspect of the invention can be combined with other aspects. Aspects can be implemented in any convenient form, for example, by appropriate computer programs, which may be carried on appropriate carrier media (computer readable media), which may be tangible carrier media (e.g., disks) or intangible carrier media (e.g., communications signals). Aspects may also be implemented using any suitable apparatus, which may take the form of programmable computers running computer programs arranged to implement the aspect. As used in the specification and in the claims, the singular forms of ‘a,’ ‘an,’ and ‘the’ include plural referents unless the context clearly dictates otherwise.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 illustrates a block diagram of an example data processing system for using long-term network storage to generate improved language model context, in accordance with one or more implementations;

FIGS. 2A-2B illustrate example user interfaces of a communication session on a client device, in accordance with one or more implementations; and

FIG. 3 illustrates an example flow diagram of a method of using long-term network storage to generate improved language model context, in accordance with one or more implementations; and

FIG. 4 illustrates a block diagram of a server system and a client computer system in accordance with an illustrative implementation.

### DETAILED DESCRIPTION

Below are detailed descriptions of various concepts related to, and implementations of, techniques, approaches, methods, apparatuses, and systems for generating improved contexts for language models. The various concepts introduced above and discussed in greater detail below may be implemented in numerous ways, as the described concepts are not limited to any particular manner of implementation. Examples of specific implementations and applications are provided primarily for illustrative purposes.

Natural language processing techniques can be applied across a wide range of computing environments to generate responses or other outputs based on natural language prompts. Language models and other machine-learning models can be used in various applications, including but not limited real-time information retrieval interfaces, which can be limited according to processing capacity of the systems executing such machine-learning models. To perform such operations, a language model can process input data sequences that represent prompts, contextual information, and other relevant data.

As language models typically include a large number of parameters, invoking such language models typically requires significant processing resources that make language models challenging to use for certain applications (e.g., real-time or near real-time applications. The number of operations and the amount of memory used to process a prompt is generally influenced by the size of the input context provided to the language model. Input contexts can include historical exchanges, metadata, and/or external reference information that may be relevant to generating an accurate or contextually suitable output. Generating suitable outputs typically involves providing large amounts of information as input to language models, which can significantly hinder performance, both in terms of accuracy and execution performance (e.g., computing resource utilization).

Conventional techniques for supplying input contexts to language models fail to ameliorate these issues. For example, conventional approaches often require sending large contexts, which often include an entire accumulated input, across multiple requests to achieve a requested output. Increasing the size of the input context results in increased network latency and bandwidth consumption. During output generation, executing language models with large input contexts causes processor load and increased memory allocation that grow at rates that reduce the feasibility of using language model in many real-time or near real-time applications. As a result, existing systems experience limited throughput, excessive memory consumption, and elevated network resource usage.

The techniques described herein address these and other issues by generating targeted input contexts for a language model that include only data determined to be relevant to a given prompt. In general, the techniques can select prompt-specific subsets of available context data based on one or more classification processes and/or rule-based policies. By constructing an input context from only the selected subset, the techniques described herein can significantly reduce the processing resources needed to process the input context without omitting information that is pertinent to generating an accurate output. Such context selection operations can be perform in connection with session-based data persistence, such that follow-on prompts can be processed according to previously stored interaction data, in some implementations.

By selectively reducing the contents of an input context based on prompt relevance and by avoiding redundant transmission of static context data, the techniques described herein can lower processing time and memory requirements for language model execution. Network bandwidth consumption can also be reduced because only incremental or newly relevant data is transmitted for follow-on prompts, rather than the entire accumulated context. These improvements can provide faster response times for multi-turn interactions, sustain throughput in high-load scenarios, and enable the use of large-scale language models within low-latency applications where conventional approaches would exceed performance constraints.

In further detail, various implementations of the systems and methods described herein can be used to reduce processor utilization and memory consumption when processing prompts with additional contextual input via one or more language models or other machine-learning models. For example, a system can maintain one or more data structures storing specific information that can be automatically selected for inclusion in an input context of the language/machine-learning models. As noted above, the computing resources (e.g., computing time and/or memory/caching consumption) used to execute language models or other natural language processing functions on computers increase at least quadratically with the size of the input context (e.g., the input data to be processed). Executing language models using existing techniques therefore restricts the context size according to the expected/target processing time of a corresponding request. For real-time or near real-time applications, such extended delays make using language models impossible to use.

To address these challenges, the systems and methods described herein can dynamically generate an input context that includes a subset of data that can be used to carry out requested computing operations. Such automatic selection may be performed, for example, according to intent classification operations executed using additional machine-learning models and/or specific rules-based selection policies. By automatically selecting certain data to be included in the input context, the systems and methods described herein automatically limit the input context for the language model to a targeted subset of available data, thereby reducing the latency (e.g., processing time) and memory allocation required to carry out the requested operations using the language model. As a result, the systems and methods described herein operate more efficiently, and allow for the use of language models in real-time or near real-time processing applications, which would otherwise be impossible to implement using existing techniques.

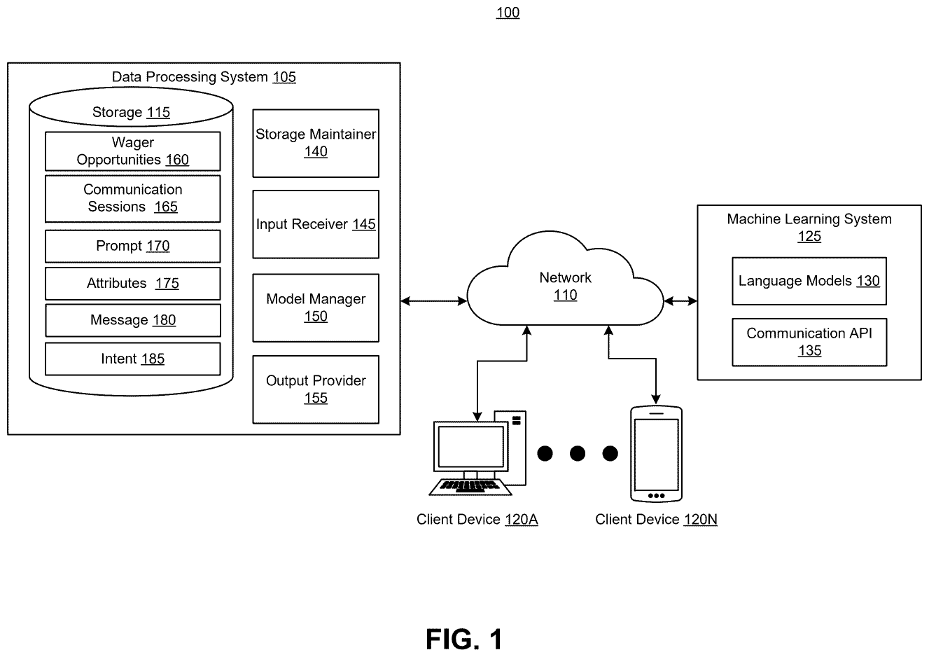

Referring now to FIG. 1, illustrated is a block diagram of an example system 100 for identifying real-time network data structure associations using language models, in accordance with one or more implementations. The system 100 can include at least one data processing system 105, one or more client devices 120A-120N (sometimes generally referred to in the singular or the plural as “client device(s) 120”) and a machine learning system 125. The data processing system 105 can be a server system, a cloud-computing platform, a local computing system, a node in a distributed network, a desktop computer, a client device, or any other system that can process information. The data processing system 105 can be or include one or multiple computing nodes, servers, or distributed processing systems. The data processing system 105 can include a storage maintainer 140, a input receiver 145, an model manager 150, an output provider 155, and at least one storage 115. The storage 115 can include one or more wager opportunities 160, communication sessions 165, prompts 170, attributes 175, messages 180, and intents 185. Although shown here as internal to the data processing system 105, the storage 115 can be external to the data processing system 105, for example, as a part of a cloud computing system or an external computing device in communication with the devices (e.g., the data processing system 105, the client device 120, etc.) of the system 100 via the network 110.

Each of the components (e.g., the storage maintainer 140, the input receiver 145, the model manager 150, the output provider 155, and the storage 115, etc.) of the system 100 can be implemented using the hardware components or a combination of software with the hardware components of a computing system, such as any other computing system described herein. Each of the components (e.g., the storage maintainer 140, the input receiver 145, the model manager 150, the output provider 155, and the storage 115, etc.) can be implemented on a single data processing system 105 or implemented on multiple, separate data processing systems 105. Although various processes are described herein as being performed by the data processing system 105, it should be understood that said operations or techniques may also be performed by other computing devices (e.g., one or more client devices 120, models of the machine learning system 125, etc.), either individually or via communications with the data processing system 105. Each of the components of the data processing system 105 can perform the functionalities detailed herein.

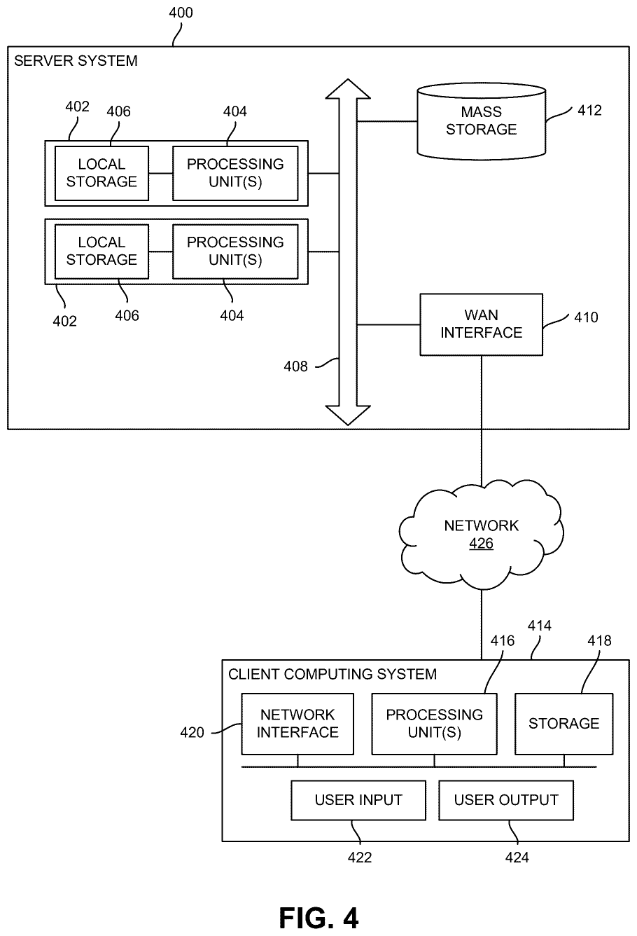

The data processing system 105 can include at least one processor and a memory (e.g., a processing circuit). The memory can store processor-executable instructions that, when executed by a processor, cause the processor to perform one or more of the operations described herein. The processor may include a microprocessor, an application-specific integrated circuit (ASIC), a field-programmable gate array (FPGA), a graphics processing unit (GPU), a tensor processing unit (TPU), etc., or combinations thereof. The memory may include, but is not limited to, electronic, optical, magnetic, or any other storage or transmission device capable of providing the processor with program instructions. The memory may further include a floppy disk, CD-ROM, DVD, magnetic disk, memory chip, ASIC, FPGA, read-only memory (ROM), random-access memory (RAM), electrically erasable programmable ROM (EEPROM), erasable programmable ROM (EPROM), flash memory, optical media, or any other suitable memory from which the processor can read instructions. The instructions may include code from any suitable computer programming language. The data processing system 105 can include one or more computing devices or servers that can perform various functions as described herein. The data processing system 105 can include any or all the components and perform any or all the functions of the computer system 400 described in connection with FIG. 4.

In some implementations, the data processing system 105 may communicate with the client device 120, for example, to receive, transmit, or process data, via the network 110. In one example, the data processing system 105 can be or can include an application server or webserver, which may include software modules allowing various computing devices (e.g., the client device 120, etc.) to access or manipulate data stored by the data processing system 105.

The network 110 can include computer networks such as the Internet, local, wide, metro or other area networks, intranets, satellite networks, other computer networks, such as mobile phone (voice or data) communication networks, or combinations thereof. The data processing system 105 of the system 100 can communicate via the network 110 with one or more computing devices, such as the one or more client devices 120. The network 110 may be any form of computer network that can relay information between the data processing system 105, the one or more client devices 120, the machine learning system 125, and one or more information sources, such as web servers or external databases, amongst others. In some implementations, the network 110 may include the Internet and/or other types of data networks, such as a local area network (LAN), a wide area network (WAN), a cellular network, a satellite network, or other types of data networks. The network 110 may also include any number of computing devices (e.g., computers, servers, routers, network switches, etc.) that are configured to receive or transmit data within the network 110.

The network 110 may further include any number of hardwired or wireless connections. Any or all of the computing devices described herein (e.g., the data processing system 105, the one or more client devices 120, the computer system 100, etc.) may communicate wirelessly (e.g., via Wi-Fi, cellular communication, radio, etc.) with a transceiver that is hardwired (e.g., via a fiber optic cable, a CAT5 cable, etc.) to other computing devices in the network 110. Any or all of the computing devices described herein (e.g., the data processing system 105, the one or more client devices 120, the computer system 100, etc.) may also communicate wirelessly with the computing devices of the network 110 via a proxy device (e.g., a router, network switch, or gateway).

The client device 120 can include at least one processor and a memory (e.g., a processing circuit). The memory can store processor-executable instructions that, when executed by the processor, cause the processor to perform one or more of the operations described herein. The processor can include a microprocessor, an ASIC, an FPGA, a GPU, a TPU, etc., or combinations thereof. The memory can include, but is not limited to, electronic, optical, magnetic, or any other storage or transmission device capable of providing the processor with program instructions. The memory can further include a floppy disk, CD-ROM, DVD, magnetic disk, memory chip, ASIC, FPGA, ROM, RAM, EEPROM, EPROM, flash memory, optical media, or any other suitable memory from which the processor can read instructions. The instructions can include code from any suitable computer programming language. The client device 120 can include at least one computing device or server that can perform various operations as described herein.

Each client device 120 can be a personal computer, a laptop computer, a television device, a smart phone device, a mobile device, or another type of computing device. Each client device 120 can be implemented using hardware or a combination of software and hardware. Each client device 120 can include a display or display portion. The display can include a display portion of a television, a display portion of a computing device, or another type of interactive display (e.g., a touchscreen, etc.). Each client device 120 may include one or more I/O devices (e.g., a mouse, a keyboard, digital keypad, buttons, trackpads, touch sensor of the touchscreen, etc.). The display can include a touch screen displaying an application, such as a web browser application or a native application, which may be used to access the functionality of the data processing system 105, as described herein.

A client device 120 can receive interactions from a user (sometimes referred to herein as a “player”). The client device 120 may also receive interactions via any other type of I/O device. The interactions can result in interaction data, which can be stored and transmitted by the processing circuitry of the client device 120. The interaction data can include, for example, interaction coordinates, an interaction type (e.g., drag, click, swipe, scroll, tap, etc.), and an indication of an actionable object (e.g., an interactive user-interface element, such as a button, hyperlink, etc.) with which the interaction occurred. The interaction data can identify a user-interface element with which the interaction occurred.

The client device 120 can be a smartphone device, a mobile device, a personal computer, a laptop computer, a television device, a broadcast receiver device (e.g., a set-top box, a cable box, a satellite receiver box, etc.), or another type of computing device. The client device 120 can be implemented hardware or a combination of software and hardware. The client device 120 can include a display or display portion. The display can include a touchscreen display, a display portion of a television, a display portion of a computing device, a monitor, a GUI, or another type of interactive display (e.g., a touchscreen, a graphical interface, etc.) and one or more I/O devices (e.g., a touchscreen, a mouse, a keyboard, digital key pad). The client device 120 can include or be identified by a device identifier, which can be specific to each respective client device 120. The device identifier can include a script, code, label, or marker that identifies a particular client device 120. In some implementations, the device identifier can include a string or plurality of numbers, letters, characters, or any combination numbers, letters, and characters. In some embodiments, each client device 120 can have a unique device identifier.

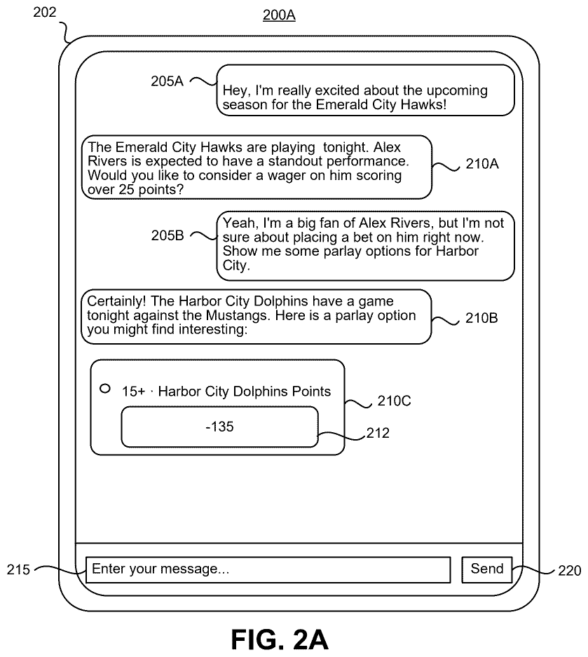

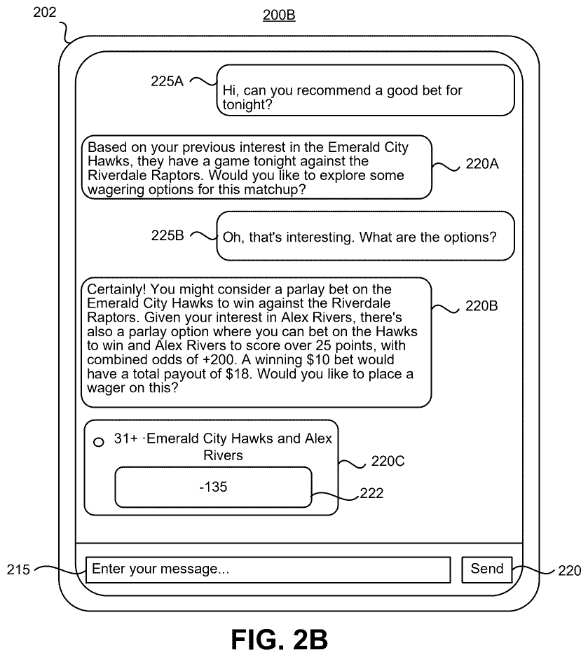

Each client device 120 can include a client application. The client application can be or include a web browser or a local application that communicates with the data processing system 105. The client application can include and/or present graphical user interfaces (e.g., the user interfaces described in connection with FIGS. 2A-2B, etc.). The graphical user interfaces may be referred to as application interfaces. The client application can initiate and/or terminate communication sessions 165. The client application can input prompts 170 into one or more communication sessions 165 and generate one or more data records. The client application can display a history of prompts 170 and messages 180 within one or more communication sessions 165. The client application can include a web application, a server application, a resource, a desktop, or a file. Other functionalities described herein may also be provided by the client application.

The client application can include a local application (e.g., local to a client device 120), hosted application, a SaaS application, a virtual application, a mobile application, or other forms of content. In some implementations, the client application can include or correspond to applications provided by remote servers or third-party servers. The application may generate or otherwise present one or more graphical user interfaces (e.g., interactive user-interface elements). The graphical user interfaces can include user-selectable hyperlinks, buttons, graphics, videos, images, or other interactive elements to control the functionality of the application make corresponding requests to the data processing system 105 to perform any of the techniques described herein. Interactions with such interactive user-interface elements (sometimes referred to as “actionable objects”) can cause the client application executing on the respective client device 120 to generate a signal, which can cause the client application to perform further operations corresponding to the actionable object.

In some implementations, the graphical user interface can present prompts 170 and messages 180 within the communication session 165. For example, the graphical user interface can display a message 180 on the odds of a bet or wager in response to a prompt 170 from a client device 120. The client application can be executing on each client device 120 and may be provided to the client device 120 by the data processing system 105 or via an application distribution platform. The graphical user interface can allow players to input prompts 170 related to sports betting, such as requests for odds for upcoming games, the likelihood of a particular team winning a match, or the potential payout for various types of bets (e.g., moneyline, point spread, or over/under). For example, if a player submits a prompt 170 asking for the latest odds on a football game, the client application can present a message 180 that displays the updated moneyline odds, showing which team is favored to win and by how much.

In some implementations, in response to interactions with graphical user interfaces, the client device 120, via the client application and/or the network 110, can send (e.g., transmit) and/or receive information (e.g., data) to the data processing system 105. The data transmitted can include information about prompts 170 (e.g., questions or text input by the users, wager amounts, selections to request information about a status of a contest, etc.).

The machine learning system 125 can include one or more language models 130 and one or more communication application programming interfaces (API) 135. The machine learning system 125 can include any type of computing system that can execute one or more machine learning models, which may include the language model(s) 130 and/or any other machine learning models described herein. The machine learning system 125 can include one or more machine learning models trained on various datasets, including but not limited to datasets for large language models. The machine learning system 125 can include a cloud system, one or more servers, a distributed remote system, or any combination thereof. The machine learning system 125 can include processing components that include, but are not limited to, one or more central processing units (CPUs), one or more graphics processing unit (GPUs), tensor processing units (TPUs), or the like. The machine learning system 125 can include a memory operable to store one or more instructions for operating components of the machine learning system 125 and operating components operably coupled to the machine learning system 125. For example, the instructions can include firmware, software, hardware, operating systems, or embedded operating systems, among others.

In some implementations, the machine learning system 125 can be internal to the data processing system 105. For example, although shown as separate from the data processing system 105, in some implementations the machine-learning system 125 (or the functionality thereof) may be implemented as part of the data processing system. In some implementations, the machine learning system 125 can be external to the data processing system 105 and can be accessed via the network 110, for example, using one or more API keys or authentication processes to process input contexts and/or prompts 170 from the data processing system 105. In some implementations, the machine learning system 125 implement or otherwise provide access to one or more application programming interfaces (APIs), via which the data processing system 105 and/or the client device 120 can access the language model 130 or other functionality of the machine learning system 125.

The language models 130 of the machine learning system 125 can include any artificial intelligence, machine learning, or deep learning models for understanding and generating human language. The language models 130 can include natural language processing (NLP) models such as large language models. The language model 130 can be trained on text data. For instance, the language models 130 can be trained/updated/fine-tuned to perform a variety of text processing tasks, including, but not limited to, generating text, formatting instructions, comprehending and processing natural language input, and responding to queries with contextually relevant information.

The language model 130 can include a transformer architecture, such as a generative pre-trained transformer (GPT) architecture. The transformer architecture can include an encoder that can process the input text and a decoder that can generate the output text. The language model 130 can include multiple layers that can operate to process and generate text. For example, embedding layers can convert words or tokens into dense vectors of fixed size, attention layers can use mechanisms such as self-attention to weigh the importance of different tokens in a sequence, and feedforward layers can apply transformations to the data to learn complex patterns. In some implementations, the language model 130 can use a self-attention mechanism to weight different parts of the input sequence when generating predictions. The language model 130 may be pre-trained (and in some implementations fine-tuned, updated, or re-trained) using large corpuses of natural language text data, such that the language model 130 can efficiently process and provide output corresponding to natural language input.

The language model 130 can receive an input context generated via the model manager 150. As described herein, the input context can include relevant wager opportunities 160 identified based on the prompt 170. The data processing system 105 can transmit the input context to the language model 130. The machine learning system 125 can execute the language model 130 to process the input context. The language model 130 can generate an output data structure including one or more tokens representing an output message generated based on the input context.

The language model 130 can process a wide range of input formats, including but not limited to text, audio, images, video, or other modalities. In some implementations, based on the input context, the language model 130 can generate output, which can range from simple text responses to complex data structures, or combinations thereof. In some implementations, the language model 130 can use the input context to iteratively predict the next token word or phrase to generate responses in response to input contexts. Tokens may include a numerical representation of text data, function calls, special separators/control signals, or any other data described herein. In some implementations, the language model 130 can generate instructions or commands that automatically invoke tools or functions to perform specific tasks or operations.

The language model 130 can receive the additional wagers via the input context. The data structure can include details regarding the wager type (e.g., moneyline, point spread, parlay) and relevant details, such as teams, odds, and bet amounts. In some implementations, the language model 130 can generate an additional data structure or update an existing data structure in response to receiving an input context that includes updated information, such as new odds for a specific wager. The data structure can include a timestamp indicating when the update occurred and a list of changes. For example, each change can specify the field that was modified. The language model 130 can transmit the updated data structure, including the updated wager data, to the client device 120 via the data processing system 105.

Natural language input can have a syntactic structure in which individual words, collections of words (e.g., phrases), or relative positions of words (e.g., word order) can indicate specific meanings. The language model 130 can be trained/updated/fine-tuned to parse sentences into their grammatical components to understand the structure and relationships between words. The language model 130 can use phrasing structure rules that define how words combine to form phrases and sentences. The language model 130 can receive an input context, which can include a sequence of tokens and/or text data structured in a format compatible with an input layer of the language model 130. In some implementations, the language model 130 may include or may be associated with a tokenizer model, which can convert a text-based or media-based input context into a sequence of tokens compatible with an input layer of the language model 130. The input context may include natural language, structured data, or combinations thereof, and may specify instructions for the model to generate particular output according to the techniques described herein.

As described herein, the input context can include relevant wager opportunities 160 identified based on the prompt. The data processing system 105 can transmit the input context to the language model 130. The machine learning system 125 can execute the language model 130 to process the input context. The language model 130 can generate an output data structure including one or more tokens representing an output message generated based on the input context. In some implementations, tokens or combinations of tokens can indicate special control data for the language model, including but not limited to the beginning of prompts/natural language text, or the beginning/end of wager opportunities, deep links, or other types of media modalities, among others.

The communication API 135 of the machine learning system 125 can facilitate interaction between the one or more language models 130 and the data processing system 105. For example, the communication API 135 can receive prompts and/or input contexts provided by the data processing system 105 using prompts 170 from a client device 120 (e.g., text queries, commands, or other forms of input). For example, the communication API 135 can receive input data from a model manager 150. Input data from a model manager 150 can include requests to allow or restrict other input data from being passed on to a language model 130, or requests to allow or restrict responses generated by a language model 130 from being output to a data processing system 105 or client device 120. The communication API 135 can forward the parsed input to a language model 130 for processing. The communication API 135 can retrieve a response generated by a language model 130 after the language model 130 has processed an input. The communication API 135 can format a response generated by a language model 130 into a suitable structure (e.g., JSON, XML) that can be easily understood and utilized by other applications. A communication API 135 can utilize authentication mechanisms (e.g., API keys, OAuth tokens) to verify the identify of a requesting identity to ensure secure communication.

In some implementations, the storage 115 can be a computer-readable memory that can store or maintain any of the information described herein. The storage 115 can store or maintain one or more data structures, which may contain, index, or otherwise store each of the values, pluralities, sets, variables, vectors, numbers, or thresholds described herein. The storage 115 can be accessed using one or more memory addresses, index values, or identifiers of any item, structure, or region maintained in the storage 115. The storage 115 can be accessed by the components of the data processing system 105, or any other computing device described herein, via the network 110. In some implementations, the storage 115 can be internal to the data processing system 105. In some implementations, the storage 115 can exist external to the data processing system 105 and may be accessible via the network 110. The storage 115 can be distributed across many different computer systems or storage elements, and may be accessed via the network 110 or a suitable computer bus interface. The data processing system 105 can store, in one or more regions of the memory of the data processing system 105 or in the storage 115, the results of any or all computations, determinations, selections, identifications, generations, constructions, or calculations in one or more data structures indexed or identified with appropriate values.

Any or all values stored in the storage 115 may be accessed by any computing device described herein, such as the data processing system 105, to perform any of the functionalities or functions described herein. In some implementations, a computing device, such as a client device 120, may utilize authentication information (e.g., username, password, email, etc.) to show that the client device 120 is authorized to access requested information in the storage 115. The storage 115 may include permission settings that indicate which users, devices, or profiles are authorized to access certain information stored in the storage 115. In some implementations, instead of being internal to the data processing system 105, the storage 115 can form a part of a cloud computing system. In such implementations, the storage 115 can be a distributed storage medium in a cloud computing system and can be accessed by any of the components of the data processing system 105, by the one or more client devices 120 (e.g., via one or more user interfaces, etc.), or any other computing devices described herein.

A communication session 165 can enable a player to interact with one or more language models 130, for example, a communication session 165 can be displayed visually on a client device 120. A communication session 165 displayed on a client device 120 (e.g., via graphical user interface) can display one or more data records. For example, a communication session 165 displayed on a client device 120 can display a plurality of prompts 170 transmitted from a client device 120 and a plurality of messages 180 transmitted from a machine learning system 125 in response to one or more prompts 170.

The storage 115 can store wager opportunities 160 for one or more live events (e.g., sports events). The wager opportunities 160 can include event information, identifying the specific live event each wager is tied to, such as participant (e.g., athletes) names, team names, game details, etc. The wager opportunities 160 can include bet options, including different types of bets available for each event, such as moneyline, point spread, or over/under, among other markets. The wager opportunities 160 can include odds, for example, the payout ratio associated with each wager and how much a winning wager would return. The wager opportunities 160 can include an indication of a live event. The live event can function as an identifier or reference, pointing to a specific ongoing live event from the available selections. The wager opportunities 160 can include an indication of a parlay or a single bet recommendation. For example, the wager opportunities 160 can include flags or markers indicating whether a wager is a parlay or a single bet. The wager opportunities 160 can include a record of the number of wagers placed. The wager opportunities 160 can include data corresponding to historical wager opportunities (e.g., past wagers) used to calculate or adjust the odds associated with the current wager opportunities.

In some implementations, odds associated with wager opportunities 160 can be dynamically adjusted based on various factors, such as live event data/developments, fluctuations in betting volume, and historical wager patterns, among others. In some implementations, upon detecting significant events, such as scores or timeouts, the data processing system 105 can recalculate and adjust wager odds. In some implementations, the data processing system 105 can track the popularity of specific wager types or specific wager opportunities, such as single game parlays, quick single game parlays (Quick SGPs), by tracking the number of times the corresponding wager types/opportunities have been selected. For example, each wager opportunity 160 can include or be associated with a counter that is incremented each time the wager opportunity is placed by a player via the data processing system 105.

The storage 115 can store or otherwise maintain one or more communication sessions 165, for example, in one or more data structures. A communication session may include a record of one or conversations or communications with a client device 120, and can include a one or more prompts 170 and messages 180. A communication session 165 can be updated in response to receiving a prompt 170 or a message 180, for example, from a client device 120 or a language model 130, respectively. A communication session 165 can be initiated or terminated by a request from the client device 120 or the data processing system 105. In some embodiments, the initiation of subsequent communication session 165 can be restricted for certain players based on one or more flags defined in one or more player profiles of different players. A communication session 165 can enable a user to interact with one or more language models 130, for example, a communication session 165 can be displayed visually on a client device 120. A communication session 165 displayed on a client device 120 (e.g., via graphical user interface) can display one or more data records. For example, a communication session 165 displayed on a client device 120 can display a plurality of prompts 170 transmitted from a client device 120 and a plurality of messages 180 transmitted from a machine learning system 125 in response to one or more prompts 170.

In some implementations, the storage 115 can store or otherwise maintain one or more prompts 170 in one or more data structures. A prompt 170 can be transmitted by a client device 120 in response to one or more interactions with an application executing on the client device 120. A prompt 170 can include text data from various sources, including a string or plurality of numbers, letters, characters, or any combination of numbers, letters, and characters. A prompt 170 can include data in one or more data structures. For example, a prompt 170 can include data that may be classified as corresponding to one or more intents 185. Prompts 170 transmitted by client devices 120 can be displayed on a client device 120, for example, during the communication session 165 to which it corresponds.

In some implementations, the prompt 170 can be a string of natural language text, such as a question, command, data related to wager opportunities, or statement, that the player provides via interaction(s) at the client device 120 or client application to communicate with the data processing system 105. For example, a prompt 170 can include, “what are the odds for today's football game?”. The prompt 170 can include numerical input, such as a request that include calculations or comparisons. The prompt 170 can be a request to perform an action, such as initiating a process, retrieving data, identifying wager recommendations, identifying application interfaces and/or webpages, generating any other information as output. The user can input a prompt 170 asking to “generate a report of all the football game scores of games played this week”. The prompt 170 can include follow-up texts to a previous interaction, where the user continues an ongoing conversation with the language model 130 (e.g., the prompt can include “Can you provide more details?”).

The storage 115 can store one or more attributes 175. The attributes 175 can include a collection of structured data by the machine learning system 125 and/or the language model 130 (or other machine learning models described herein) to perform specific tasks. The data processing system 105 can collect data from sources such as sports data providers, betting platforms, player interactions, and more, through data extraction. The data processing system 105 can address missing values, inconsistencies, and outliers to maintain data quality, for example, through data cleaning or preprocessing. The data processing system 105 can aggregate data from multiple sources to generate the attributes 175. In some implementations, the data processing system 105 can generate additional training examples for attributes 175, for example, using data augmentation techniques.

The attributes 175 can include data on players (e.g., client application users). The attributes 175 can be structured data. Attributes 175 for players can include individual player demographics (e.g., age, geographic location) and statistics such as betting history and wagering patterns. Attributes 175 can include numerical data such as records of past wagers, such as amounts, odds, outcomes, and live event types. Attributes 175 can include preferred wager types (e.g., parlays, teasers), time of day of wagers, and frequency of wagers. Attributes 175 can include engagement levels metrics related to player interaction with the client application, such as time spent on the client application and frequency of logins and/or interactions. The attributes 175 can include data that relates to the preferences and interests of the players, such as favorite sports team, favorite type of live events.

The storage 115 can store or otherwise maintain one or more messages 180 in one or more data structures. Each message 180 can be generated by one or more language models 130 and transmitted via one or more communication APIs 135 to the data processing system 105 (or any components thereof). A message 180 may be an output message generated by the language model 130 and/or the machine learning system 125. The message 180 may include text data, such as letters, characters, or any combination of numbers, letters, and characters. For example, when a prompt 170 and/or supplemented input context is received, the language model 130 can processes the input context and generates a message 180 that contains relevant data or information as a response (e.g., wager opportunities 160). Records of conversations including both prompts 170 and corresponding messages 180 can be stored in one or more data structures as a historical record of one or more communication sessions 165.

The storage 115 can store or otherwise maintain one or more intents 185 in one or more data structures. An intent 185 can be generated the data processing system 105 or by a language model 130. For example, an intent 185 can be generated by a input receiver 145 and/or model manager 150. An intent 185 can be generated in response to a determination by a language model 130. An intent 185 can be generated for a corresponding prompt 170 or set of prompts 170 transmitted during a communication session 165. An intent 185 can indicate the purpose. For example, a prompt 170 can have an intent 185 associated with a request for wagers, which may include a wager for particular sport(s), live event(s), team(s), participant(s), wager type(s), or any other intent information. The intent 185 may be a request for information, a request to update wager opportunities, player profile information, bet slips, or any other information described herein.

The data processing system 105 and/or the language model 130 within the machine learning system 125 can generate the intent 185 and store the intent 185 in the storage 115 for further use. The intent 185 can be determined from factors within the communication sessions 165, such as the content of prompts 170, and in some implementations further based on one or more messages 180 and/or input contexts that are intended to be provided to the language model 130 for processing. An intent 185 can be determined or derived from a prompt 170, the content of a message 180 or prompt 170, the length of the message 180 or prompt 170, the number of messages 180 or prompts 170, or the number of a subset of messages 180 or prompts 170 within a communication session 165, among other factors.

In some implementations, the data used for processing wager opportunities and the data used to generate the message 180 can be structured differently. For example, for parlay wager opportunities, the message 180 can hierarchical layouts or graphical elements, in some implementations. In some implementations, the message 180 can include interactive elements such as buttons or links that, when clicked or interacted with, automatically cause the application presenting the interactive elements to transmit requests to place one or more wagers corresponding to the wager opportunities 160.

In some implementations, the language models 130 and/or the machine learning system 125 can implement additional or alternative NLP techniques to determine or extract intents 185 from prompts 170. For example, additional machine learning models including transformers, recurrent neural networks (RNNs), named entity recognition (NER), and sentiment analysis models may be used to generate classification(s) of intents 185 for one or more prompts 170. The NLP techniques can be used to process and analyze the text of a prompt 170 to determine the intent 185. NLP techniques can include breaking down a prompt 170 into multiple phrases or segments based on word choice, sentence structure, and context.

In one example, tokenization can be used to break down a prompt 170 into individual words or phrases, which can be processed by the language model 130 or other machine learning models to implement syntactic and semantic analysis and to determine an intent 185. The language models 130, via NLP techniques, can determine the intent 185 across multiple prompts 170 within the same communication session 165. For example, if a player submits multiple prompts 170 about sports betting odds, the data processing system 105 can determine an intent 185 related to sports betting even if keywords are not repeated in every prompt 170. The use of NLP techniques can enhance the ability of the data processing system 105 to interpret complex prompts 170, ensuring that intents 185 are accurately determined. In another example, if the player submits the prompt 170, “What are the odds for Team A tonight?”, the secondary language model can analyze the prompt 170 and classify the intent 185 as a request for odds information of one or more wagers for “Team A”.

In some implementations, a prompt 170 or set of prompts 170 in a communication session 165 can be classified as relating to a request for information relating to the attributes 175 of one or more participants or teams. As described in further detail herein, a prompt 170 may be classified as including an intent 185 indicating a request for a participant or team having certain attributes, which may further include an intent 185 relating to a request for a wager opportunity. Any type or combination of intents 185 can be derived from any number of prompts 170 and/or messages 180 provided in a communication session 165. In some implementations, the intent 185 can indicate the type of attributes, participant identifiers, team identifiers, or any other information that may be extracted from the prompt(s) 170 and/or message(s) 180 that can be used to identify information relating to one or more attributes 185.

Referring now to the operations of the data processing system 105, the storage maintainer 140 can maintain a plurality of wager opportunities 160 that correspond to one or more live events (e.g., sport events, any other event that may involve wagering). The one or more live events may include events that are currently live or upcoming events that are to occur live. The storage maintainer 140 can store the wager opportunities 160 in the storage 115. Each of the plurality of wager opportunities 160 can identify at least one of a plurality of teams. For example, a wager opportunity 160 for a soccer game can identify “Team A” and “Team B”, and can offer options to bet on the outcome of the soccer match, such as which team will win (moneyline) or how many goals each team will score (over/under). The storage maintainer 140 can maintain in the storage 115 a plurality of wager opportunities 160 identifying at least one of a plurality of participants in the live events. For example, in a basketball game, wager opportunities 160 can include wagers on participants (e.g., athletes), such as predicting how many points a participant will score or whether a participant will achieve a triple-double.

The storage maintainer 140 can maintain, in the storage 115, one or more attributes 175 (e.g., player profiles) of a plurality of player profiles. Each player profile of the plurality of player profiles can include a plurality of player attributes 175. The storage maintainer 140 can access data identify wager opportunities 160 in response to prompts 170 having an intent 185 corresponding to player attributes 175. The player attributes 175 can be organized in a structured data format. The storage maintainer 140 can access and query the player attributes 175 through unique identifiers, such as player names, or player identifiers (e.g., IDs). The one or more player profiles can include player's betting history, preferred wager types, favorite teams or participants, and other behavioral patterns or preferences extracted from previous interactions.

The player attributes 175 can include a betting history of each player (e.g., “Player A” has placed wagers predominantly on basketball games). The player attributes 175 can include preferred wager types (e.g., parlay wagers, moneyline, etc.). The player attributes 175 can include favorite teams or participants (e.g., “Player A” often bets on “Team X” or “Athlete Y”). The player attributes 175 can include wagering patterns, such as average wager amounts (e.g., “Player A” average wagers $50 per live event) or frequency of wagers (e.g., e.g., average of 10 wagers per week). The player attributes 175 can include demographic information such as city of residence. The player attributes 175 can include engagement metrics, such as interaction history with the application or platform (e.g., number of logs per month). The player attributes 175 can also include recent interests expressed in communication sessions 165 (e.g., “Player A” has shown interest in tennis during recent chats).

The player attributes 175 can be utilized to tailor wager opportunities 160 to each player's preferences and behaviors, enhancing the overall user experience. The player attributes 175 can include wager type, athletes, teams, types of live events (e.g., sports), or indications of others. For example, the city of residence can be used to offer wager opportunities on local teams or events (e.g., “Player A” residing in Boston can receives recommendations for wager opportunities involving teams based in Boston). The player attributes 175 can also inform the selection of wager types presented to the player. If a player has a preferred wager type (e.g., parlay wagers), the data processing system 105 can offer similar wager opportunities (e.g., suggesting new parlay combinations). Favorite teams or participants identified in the player attributes 175 can allow the data processing system 105 present and/or notify the player of upcoming wager opportunities including the favorite teams or athletes.

The data processing system 105 can include the input receiver 145. The input receiver 145 can be or include any script, file, program, application, set of instructions, or computer-executable code that is configured to process input data in the form of a prompt 170. The input receiver 145 can include hardware, software, or any combination. A prompt 170 can include any player-provided command, request, or text data. The prompt 170 can include a request or information relating to wager recommendations, live events, participants, teams, or other types of requests. The prompts 170 can include any type of information that may be used to classify the intent 185 of the prompt 170, including but not limited to an indication of a wager type, a wager amount, or indications of live events, participants, teams, or outcomes. The input receiver 145 can receive the prompt 170 from the client device 120 in natural language (e.g., a text string). The input receiver 145 can receive prompts 170 through player interactions with the application interface. Player interactions can include clicking buttons, entering text, or using voice commands within one or more application interfaces, among others. In some implementations, the input receiver 145 can identify specific events or triggers, such as player actions or system state changes, which can generate prompts 170.

In some implementations, the communication session 165 can be a conversation record involving prompts 170 transmitted by a client device 120 associated with a player profile and messages 165 generated by one or more language models 130. The input receiver 145 can receive a prompt 170 for the language model 130 from the client device 120 during the communication session 165. Upon receiving the prompt 170 for a communication session 165, the input receiver 145 can store the prompt 170 in association with the communication session 165 and can provide the prompt 170 to other components of the data processing system 105 to determine an intent 185 for the prompt 170. The input receiver 145 can receive and process the prompt 170 and/or the request to allow the data processing system 105 to generate a response (e.g., message 180, wager opportunity 160, etc.) based on relevant data.

The input receiver 145 can receive and store the communication sessions 165 in the storage 115. Each communication session 165 can include a record of prompts 170 and messages 180 exchanged between the client device 120 and the data processing system 105. By maintaining the communication sessions 165, the input receiver 145 can have access to historical interaction data for each player profile. The input receiver 145 can parse and process the communication sessions 165 (e.g., prompts 170 from the communication sessions 165) to extract information, such as attributes 175, wager type, amount, and game selections, among others. The input receiver 145 can execute functions in response to receiving communication sessions 165. The input receiver 145 can provide communication sessions 165 and any information extracted therefrom, to other components of the data processing system 105 and/or the machine learning system 125 for further processing according to the techniques described herein. The input receiver 145 can format the prompts 170 from the communication sessions 165 into a standardized data structure, in some implementations. The input receiver 145 can collect or store records of player prompts 170 in the storage 115.

The input receiver 145 can extract key terms or phrases that correspond to attributes 175. The input receiver 145 can use natural language processing techniques described herein to determine the attributes 175 corresponding to an intent 185 of the communication sessions 165. The input receiver 145 can extract text data from the plurality of communication sessions 165 based on one or more extraction criteria. The extraction criteria can include keywords, phrases, sentiment analysis, or frequency of certain topics mentioned by the player. For example, if a player frequently discusses a sport or a wager type during communication sessions 165, the input receiver 145 can identify and extract text data. The text data can then be used to update the player attributes 175 within the corresponding player profiles. By analyzing the communication sessions 165, the input receiver 145 can identify changes in player preferences, new interests, or shifts in wagering behavior. The continuous updating of player attributes 175 allows the data processing system 105 to generate more personalized wager recommendations.

The extraction criteria can include keywords or phrases that indicate the player's interests, such as names of sports (“basketball,” “baseball”), teams (“Team X,” “Team Y”), participants (“Athlete A,” “Athlete B”), or wager types (“parlay,” “over/under,” “moneyline”). Sentiment analysis can be used to gauge the player's positive or negative sentiments toward certain teams or wager types. For example, if a player expresses enthusiasm with phrases like “I'm excited about Team Z's game tonight” or “I love betting on underdogs,” the input receiver 145 can update the player attributes 175 to reflect a positive sentiment toward “Team Z” and an interest in underdog wagers. Negative sentiments such as “I'm not interested in over/under bets anymore” can be used to adjust the player's attributes 175. The frequency of certain topics mentioned by the player can also serve as extraction criteria. If a player repeatedly inquires about “in-play wagers” or “first scorer bets” across multiple communication sessions 165, the input receiver 145 can determine a strong interest in those wager types.

The input receiver 145 can preprocess the text data extracted from the communication sessions 165 to remove one or more words, phrases, or symbols. This preprocessing may involve eliminating common stop words such as “and,” “the,” “is,” and other filler words that do not contribute meaningful information to the analysis. The input receiver 145 can remove punctuation marks, special characters, or irrelevant emojis that can interfere with accurate keyword extraction. By cleaning the text data, the input receiver 145 enhances the effectiveness of natural language processing techniques used to determine the attributes 175 corresponding to the intent 185.

The preprocessing can include converting all text to a uniform case (e.g., lowercase) to ensure consistency in analysis. The input receiver 145 can perform stemming or lemmatization to reduce words to their base or root forms, allowing for better matching of keywords (e.g., converting “betting,” “bets,” and “betted” to “bet”). The input receiver 145 can remove redundant spaces or line breaks that may have been introduced during data entry. The input receiver 145 can determine a semantic score for the one or more extracted keywords, assessing their relevance and significance within the communication sessions 165. The semantic score can be calculated using natural language processing techniques (e.g., term frequency-inverse document frequency (TF-IDF), etc. ), word embeddings, or sentiment analysis. These methods quantify how strongly each keyword or phrase is associated with the player's interests or behaviors.

For example, if a player frequently mentions “live betting” or “underdog wins”, these extracted text data can receive higher semantic scores due to their repeated occurrence and contextual importance. The input receiver 145 can then update player attributes 175 (e.g., player profile) based on the semantic score determined for each of the keywords. Keywords with higher semantic scores may lead to the enhancement or addition of corresponding attributes 175. For example, if “parlay bets” receives a high semantic score, the data processing system 105 can update the player attributes 175 on preferred wager types to include parlay wagers. Keywords with lower semantic scores can have a lower impact on the player attributes 175. By updating the player attributes 175 based on semantic scores, the data processing system 105 ensures that the player profile accurately reflects the player's most significant interests and preferences, enabling more personalized and relevant wager opportunities 160 to be offered.

An intent 185 can identify or otherwise indicate the meaning and intent of a prompt 170 received via one or more communication sessions 165. In some implementations, an intent 185 can be generated by the input receiver 145 and/or model manager 150 using the prompts 170 and/or output messages 180 in a corresponding communication session 165. The intent 185 can be determined using any suitable intent classification technique, including natural language processing techniques.

In some implementations, the intent 185 of a prompt 170 can be generated using a language model 130. As described herein, the language model 130 can be trained on a large corpus of data to recognize patterns and semantic structures that correspond to various intents 185 or portions thereof. By applying this trained model to the prompts, the input receiver 145 can identify the specific intent 185 that the user is conveying. Determining the intent may include prompting or instructing the language model 130 to extract one or more keywords or phrases, as well as generate text, identifiers of classifications, or other indications of particular intents, including but not limited to requests for wager opportunities (e.g., having particular wager types, wager attributes, team names, athlete names, wager characteristics, etc.), requests for information (e.g., information relating to sporting events, types of wager opportunities, athletes, upcoming, current, or past events, etc.), or other types of requests. The intent 185 may be formatted/generated by the input receiver 150 to conform to structured format, such as a JavaScript Object Notation (JSON) format, among other formats.

In some implementations, the input receiver 145 and/or model manager 150 can use rule-based techniques to identify player intents 185. For example, the input receiver 145 and/or model manager 150 can use a set of predefined rules or patterns that match specific prompts to predefined intents. In some implementations, the input receiver 145 and/or model manager 150 can use keyword matching or regular expressions to identify patterns that capture variations in prompts. For example, a rule can specify that a prompt related to placing a wager may indicate a betting intent. In some implementations, the model manager 150 can use machine learning models to identify a wider range of intents, including those that are context-dependent or ambiguous. For example, the model manager 150 can use implement vector machines (SVMs), naive bayes, or deep learning architectures such as recurrent neural networks (RNNs), or language models including transformer models such as BERT, DistilBERT, or generative pre-trained transformer (GPT)-based models. The models can be trained on large datasets of player prompts and their corresponding intents. The model manager 150 can use the machine learning model(s) (e.g., machine learning system 125) to distinguish between player intents 185, such as checking odds, placing wagers, requesting wager recommendations or information based on attributes 175 of participants or teams, or requesting payouts, among other prompts.

In some implementations, the model manager 150, via the language models 130, can extract keywords from the text data based on a named-entity recognition (NER) process. The model manager 150, via the language models 130, can identify and categorize the extracted text data into predefined groups such as names of persons, organizations, locations, expressions of time, quantities, monetary values, etc. By applying NER to the text data from the communication sessions 165, the input receiver 145 can accurately identify relevant player attributes.

The input receiver 145 and/or model manager 150 can process prompts 170 to classify/determine the underlying intent 185 or purpose of the prompts 170. The model manager 150 can categorize the player's prompt 170 into specific intents, such as placing a bet, checking odds, or requesting information about a specific participant attributes or team attributes. The model manager 150 can determine the actions to fulfill the player's request based on the classified intent. For example, if a player enters the prompt “What are the odds for Team A to win tonight?”, the model manager 150 can determine that the prompt is a request for wagering information, identify the specific wager type as a moneyline bet, and extract attributes 175 such as the team's name (in this example, Team A) and the game timeframe (in this example, tonight).

The intent 185, once generated, can provide the underlying meaning of the prompt 170. The intent 185 can be used to derive attributes 175 of the player, which can include interests or preferences for potential future wager opportunity recommendations. For example, if a player submits prompts 170 in the communication sessions 165 such as “Show me the best parlay bets for tonight's football games,” the intent 185 can be classified as a request for parlay wager opportunities 160 related to football. The input receiver 145 can extract this intent 185 by identifying keywords and phrases related to wager types (“parlay bets”) and sports (“football”). The model manager 150 can then use this intent 185 to query the storage 115 for relevant wager opportunities 160 that match the player's preferences (e.g., attributes 175), which in this example may include football teams or athletes that the player has requested information on or wager opportunities 160 for in the past.

The intents 185 can be used to update attributes 175 stored in the player profile of different players accessing the functionality of the data processing system 102. For example, if a player frequently asks (e.g., in prompts 170) about a team or athlete in one or more communication sessions 165, the player profile of that player can be updated to indicate a strong interest in that team or athlete. Example prompts 170 like “What's the over/under for Team X tonight?” can cause the input receiver 145 and/or model manager 150 to update the player's favorite teams attribute 175 to include “Team X.” The updated attribute 175 allows the data processing system 105 to personalize future wager recommendations, prioritizing wager opportunities 160 involving “Team X.” In some implementations, the intent 185 can indicate an interest in a new sport or wager type, depending on the current attributes 175 of the player profile. For example, if a player begins submitting prompts 170 in communication sessions about a different sport (e.g., “I'm interested in upcoming hockey matches”) than indicated in the attributes 175 for that player, the intent 185 can be used to update the attributes 175 to reflect the new interest. The input receiver 145 and/or model manager 150 can update the player attributes 175. The attributes 175 may store counters or scores that indicate a frequency with which a player has submitted one or more prompts 170 that indicate corresponding athletes, teams, live events, wager opportunities, or other types of wager-related information. The scores for each attribute 175 may be proportional to the player's interest in the particular attribute. The scores may be a function of the number of prompts 170 identifying/relating to the corresponding attribute 170, the number of communication sessions 165 identifying/relating to the corresponding attribute 170,

The intent 185 can identify wager types implied or specified in one or more prompts 170. For example, if the player submits prompts 170 in the communication sessions 165 such as “What are the best parlay options for the upcoming matches?”, “Can you recommend some high-risk, high-reward bets?”, or “I'm interested in combining multiple games into one bet tonight,” the intent 185 can be determined as a preference for parlay wagers. The information extracted can be used to update the player's preferred wager types in their attributes 175. By updating the player attributes 175 to reflect this preference, the data processing system 105 can tailor future wager opportunities 160 to include more parlay options. By continuously analyzing communication sessions 165 and updating intents 185 and player attributes 175, the data processing system 105 can ensure that wager recommendations 160 remain dynamic and closely aligned with the player's interests and behaviors.

The data processing system 105 can include the model manager 150. The model manager 150 can be or include any script, file, program, application, set of instructions, or computer-executable code that is configured to determine the classification of the request included in a player input, referred to as a prompt. Similar to the input receiver 145, the model manager 150 can parse prompts 170 received from the client device 120 as part of communication sessions 165 to determine an intent 185 of the prompts 170 and to update the player attributes 175. The data processing system 105 can use the model manager 150 to generate an input context for the language model 130 using player attributes 175, received prompt(s) 170, other output messages/prompts 170 in a communication session 165, and/or one or more wager opportunities 160. The input context can be generated to include a variety of information, such as prompts, questions, which may include previous prompts/messages of a conversation (e.g., a communication session 165). The model manager 150 can identify the desired action or information sought by the player. The input context can include a representation of the player's historical interactions, preferences, current requests, and relevant wagering options, which may be extracted and/or identified from a corresponding player profile (or attributes 175 thereof).

In some implementations, when generating an input context to process a prompt 170 indicating a request for a wager opportunity 160, the model manager 150 select at least one wager opportunity 160 based on a similarity between data of the wager opportunity 160 and the plurality of player attributes 175 of the player that submitted the prompt 170. The similarity assessment can include comparing various aspects of the wager opportunities 160—such as teams involved, participants, wager types, and event details—with the corresponding attributes 175 of the player. For example, if a player's attributes 175 indicate a strong interest in “parlay bets”, “Team X” and “Athlete Y”, the model manager 150 can evaluate wager opportunities 160 that includes such elements. The higher the similarity between the wager opportunity 160 and the player's attributes 175, the more likely that wager opportunity 160 will be selected for recommendation.

The input receiver 145 and/or model manager 150 can select a subset of the plurality of wager opportunities 160 that identify one or more participants from a plurality of participants that satisfy the attribute 175. This process involves filtering through the available wager opportunities to find those that align with the player's updated attributes 175. For example, if the player's attributes 175 indicate a preference for “Athlete A” or “Team X,” the data processing system can prioritize wager opportunities 160 involving these participants or teams. The input receiver 145 and/or model manager 150 can match attributes 175 such as favorite teams, preferred wager types, or recent interests with corresponding details in the wager opportunities 160.

The selection process may include evaluating various factors within the wager opportunities 160, such as the type of wager (e.g., moneyline, over/under, parlay), the participants involved, and the event's relevance to the player's preferences. The model manager 150 can use this information to generate a personalized set of wager recommendations. For instance, if the player has shown a recent interest in high-stakes parlay bets on basketball games, the system can select wager opportunities 160 that feature parlay options for upcoming basketball matches.

In some implementations, the model manager 150 may generate an input context for the language model 130 by retrieving various additional information relating to the intent 185 of the prompt, including but not limited to data of one or more wager opportunities, data from one or more webpages, information corresponding to one or more attributes 175, application interfaces, or information sources, odds information for one or more wager opportunities, player profile information, historical wagering information for one or more live events, teams, live event participants, or other data, among any other information that may be processed by the language model 130. The input context may be a sequence of characters, tokens, or structured data that is to be provided as input to the language model 130. Data can be provided to the language models 130 via the communication APIs 135 of the machine learning system 125, in some implementations. Messages 180 generated by the language model 130 can be received by the model manager 150 and/or the output provider 155, as described herein, and may be provided for presentation at the client device 120 communicating.

The model manager 150 can generate, using the language model 130, the prompt 170, and attributes 175, an output message 180 identifying at least one wager opportunity 160 from the plurality of wager opportunities selected based on the player profile (e.g., attribute 175). For example, if a player submits the prompt 170 “What are some betting options for tonight's basketball games?”, the model manager 150 can utilize the language model 130 to process this prompt 170 in conjunction with the player's attributes 175. If the player's profile indicates a preference for parlay wagers and a frequent interest in “Team X,” the model manager 150 can generate an output message 180 that identifies parlay wager opportunities 160 involving “Team X” in the upcoming basketball games. In another example, if the player submits a prompt 170 “I'm interested in high-reward bets for the upcoming soccer matches,” and the player's attributes 175 indicate a preference for underdog teams and higher wager amounts, the model manager 150 can generate an output message 180 identifying wager opportunities 160 that offer higher payouts, such as betting on an underdog team to win or specific score predictions.

The model manager 150, via the machine learning system 125 and/or language model 130, can map extracted keywords, phrases, or indications from the prompt 170 and/or intent 185 to specific attributes 175. For example, the model manager 150 can link keywords such as “parlay,” “over/under,” or “moneyline” from the prompt 170 to the player's preferred wager types in the attributes 175. If a player frequently mentions “parlay bets” in their communication sessions 165, the model manager 150 and/or storage maintainer 140 can update the preference for parlay wagers in the player attributes 175. The mapping may further provide different mappings for different live event types (e.g., different sports), participants, teams, or other factors that may affect the context or semantic meaning of the keywords, phrases, or indications. In some implementations, the semantic classification techniques described herein may be implemented to identify the mapping(s) between keywords, phrases, or indications in prompts and corresponding attributes 175.

In some implementations, the model manager 150 can search or perform one or more selection/identification actions using the attributes 175 based on one or more keywords, phrases, or indications in the prompt and/or in the intent 185. In one example, if the prompt 170 includes the phrase “I want to bet $500 tonight”, the model manager 150 can use the player's attributes 175 such as geographic location, favorite sport, favorite team, and preferred betting type to present a wager opportunity 160. For example, if the player's profile (attributes 175) indicates that they are located in Boston, have a favorite sport of basketball, and prefer “moneyline” bets, the model manager 150 can identify an upcoming basketball game involving a team in the Northeast and offer a moneyline wager opportunity 160 with a stake of $500.

In some implementations, the prompt 170 can include a request for a wager recommendation. The model manager 150 can generate, using the language model 130 and the prompt 170, an output message 180 identifying at least one wager opportunity 160 of the plurality of wager opportunities 160 in the storage 115 selected based on the player attributes 175. The model manager 150 can select a subset of the wager opportunities 160 that satisfy the attribute 175 indicated in the request/prompt 170. The model manager 150 can access the attribute 175 data from the storage 115. The model manager can filter through the wager opportunities 160 to identify wager opportunities 160 that most closely match the attributes 175. For example, if a player submits the prompt 170 such as “What are some good bets for tonight's football games?”, the model manager 150 can utilize the player's attributes 175—such as favorite teams, preferred wager types, and historical betting patterns—to select relevant wager opportunities 160. The language model 130 can process the prompt 170 in conjunction with the player attributes 175 to generate an output message 180. The message 180 can include wager opportunities 160 (e.g., recommendations) that align with the player's interests, such as suggesting a moneyline bet on the player's favorite team or highlighting a parlay involving teams the player frequently bets on. By tailoring the wager opportunities 160 to the player attributes 175 (e.g., player's preferences), the model manager 150 can enhance the relevance and appeal of the recommendations.

The model manager 150 can generate an output message 180 based on the input context, including the player's prompt 170 and historical interactions. For example, if a player previously expressed interest in a sporting team, such as Team Z during a communication session 165 without acting on it, and later submits a prompt 170 like “Can you recommend a good bet for tonight?”, the model manager 150 can generate an output message 180 that identifies a wager opportunity 160 involving Team Z. The output message 180 may state, “Because you showed interest in Team Z earlier, you might consider placing a wager on their game tonight. Here are some betting options you might like.”.

In some implementations, the model manager 150 can refine the wager opportunities 160 by considering attributes 175 such as player's wagering patterns, such as average wager amounts and frequency of bets. If the player's attributes 175 show an average wager amount of $100 and a preference for moderate-risk bets, the model manager 150 can select wager opportunities 160 that align with these parameters. In another example, if a player with attributes 175 indicating an interest (e.g., a high relevancy score, etc.) in high-reward bets and a favorite participant in “Athlete Z,” and submits the prompt 170, “Any suggestions for big wins tonight?”, the model manager 150 can select wager opportunities 160 that involve “Athlete Z” in propositions bets with higher odds. The model manager 150 might offer a wager opportunity 160 such as betting on “Athlete Z” to score the first goal in a soccer match, which typically offers a higher payout due to its increased risk. Based on combined prompts 170 and/or communication sessions 165, the data processing system 105 can extract relevant information about player preferences (attributes 175).

The output provider 155 can receive any messages 180 generated by the language model 130 in response to providing one or more prompt(s) 170 and/or input contexts to the language model 130 for processing. In some implementations, the output provider 155 can format the response messages 180 received via the communication API 135 into a suitable structure that allows it to be displayed on a client device 120. In some implementations, the output provider 155 can display messages 180 using display instructions specified via a structured format, such as a JSON or XML format.

FIGS. 2A-2B illustrate example user interfaces of an application executing on a client device presenting a communication. Referring to FIG. 2A in the context of the components described in connection with FIG. 1, illustrated is an example diagram 200A showing a graphical user interface 202. The graphical user interface 202 can be displayed as part of the communication session 165. The graphical user interface 202 can be displayed on the client device 120. The graphical user interface 202 can include an input field 215 that can receive input (e.g., prompt 170) from the user (e.g., player). The graphical user interface 202 can include a send button 220 that can initiate the transmission or sending of the input (e.g., prompt 170) from the client device to the computing system providing the communication session 165 (e.g., the data processing system 105).

In this example, the player has provided prompts 205A-205B during a first communication session 165. The graphical user interface 202 can display, via data received from the data processing system 105, messages 210A-210C (e.g., messages 180) generated using a language model 130 based on the prompts 205A-205B according to the techniques described herein. For example, prompt 205A can be a prompt expressing interest in a team (e.g., Emerald City Hawks). The data processing system 105 can receive the prompt 205A using natural language processing techniques to extract key terms or phrases, such as the team name “Emerald City Hawks”.

The data processing system 105 can identify “Emerald City Hawks” as a team of interest and present a wager opportunity 160 to the player. The data processing system 105 can update the player's profile to include this team as of interest (not necessarily favorite) within the plurality of player attributes 175. For example, the data processing system 105 an present a message 210 A which states, “The Emerald City Hawks are playing tonight. Alex Rivers is expected to have a standout performance. Would you like to consider a wager on him scoring over 25 points?”. The player can respond and express interest in Alex Rivers and the team but not pursue a wager opportunity, as shown in prompt 205B. Similarly, the data processing system 105 can update the player's profile to include this athlete as of interest (not necessarily favorite) within the plurality of player attributes 175. The player can request betting options for another team (“Harbor City” in this case). The data processing system 105 can determine from the prompt 205B that “Harbor City” is the name of a team and not a geographic location. The graphical user interface 202 can display a message 210B and 210C which responds to the player question and can offer to suggest wager option.

The data processing system 105 can receive text data entered into the prompt 205B as a prompt from the client device 120 over the network 110. The data processing system 105 can determine the classification of the intent of the request included in the prompt 205B, such as identifying the desired wager type and relevant player or team. The data processing system 105 can generate an input context for the language model 130 based on the classified prompt. The language model 130 can process the input context (which can include the prompt, identified wager opportunity data, etc.) to generate a data structure corresponding to one or more wager opportunities. The client device 120 can parse the data structure to display a specific wager option 210B via the graphical user interface 202, such as “Here is a parlay option you might find interesting:”, along with an additional output such as “The graphical user interface 202 can display the odds 212 associated with the generated wager option 210C. The odds 212 can indicate betting dynamics. For example, negative odds, such as −135, can indicate that the player is to wager $135 to win $100, and positive odds can indicate the potential winnings from a $100 wager.

FIG. 2B presents another communication session 200B by the same player, performed at a later time. As shown in FIG. 2B, when a player submits the prompt 225A “Hi, can you recommend a good bet for tonight? the data processing system 105 can identify the player's intent to place a wager, and can generate, using the language models 130, the prompt 170, and the update attribute 175 from a previous communication session (e.g., communication session 200A) an output message identifying at least one wager opportunity selected based on the plurality of player attributes 175 (which includes an interest in Emerald City Hawks and Alex Rivers).

The graphical user interface 202 can display a message 220A which states, “Based on your previous interest in the Emerald City Hawks, they have a game tonight against the Riverdale Raptors. Would you like to explore some wagering options for this matchup?”. The data processing system 105 can also generate the output message 220 to include candidate wager opportunities selected based player attributes 175 (which includes an interest in Emerald City Hawks and Alex Rivers), along with an additional output such as “You might consider a parlay bet on the Emerald City Hawks to win against the Riverdale Raptors. Given your interest in Alex Rivers, there's also a parlay option where you can bet on the Hawks to win and Alex Rivers to score over 25 points, with combined odds of +200. A winning $10 bet would have a total payout of $18. Would you like to place a wager on this?”. The graphical user interface 202 can display the odds 222 associated with the generated wager option 210E.

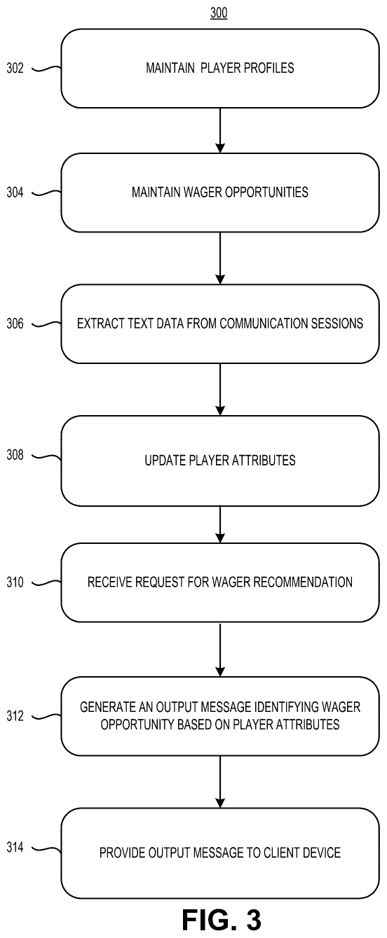

Referring to FIG. 3, illustrated is an example flow diagram of a method 300 for identifying real-time network data structure associations using language models, in accordance with one or more implementations. In brief overview of the method 300, the data processing system (e.g., the data processing system 105, etc.) can maintain a plurality of player (STEP 302), maintain a plurality of wager opportunities corresponding to a plurality of live events (e.g., sport game or match) (STEP 304), extract, from a plurality of communication sessions identifying a first player profile of the plurality of player profiles, text data (STEP 306), update the player attributes the text data (STEP 308), receive, from a player profile, a prompt comprising a request for a wager recommendation (STEP 310), generate, using a language model and the prompt, an output message identifying wager opportunities selected based on player attributes (STEP 312), and provide the output message to the client device in response to the request (STEP 314),

In further detail of method 300, at STEP 302, the data processing system can maintain a plurality of player profiles. Each player profile of the plurality of player profiles can include a data structure identifying a plurality of player attributes. The player attributes (e.g., attributes 175) can include a player's favorite team, favorite athlete, average wager amount, preferred wager type, etc. Attributes can include any information or details related to players. The attributes can include numerical data, alphanumerical data, categorical data, and text. At STEP 304, the data processing system can maintain a plurality of wager opportunities (e.g., multiple betting options) corresponding to a plurality of live events (e.g., ongoing or upcoming sport games).

At STEP 306, the data processing system can extract, from a plurality of communication sessions identifying a first player profile of the plurality of player profiles, text data. The text data can satisfy one or more extraction criteria. include keywords, phrases, frequency of certain topics, etc.

At STEP 308, the data processing system can update the plurality of player attributes using the text data. The data processing system can update the player attributes based on sentiment analysis, semantic scores, etc. At STEP 310, the data processing system can receive, from a client device (e.g., smartphone, tablet, or computer), a prompt comprising a request for a wager recommendation. The client device can be associated with a player or player profile. A player can send the prompt from the client device. The data processing system can identify a requested prompt and map it to a player profile (attribute).

At STEP 312, the data processing system can generate, using a language model, the prompt, and at least a portion of the attributes, an output message identifying at least one wager opportunity of the plurality of wager opportunities selected based on the prompt. The language model can include a natural language processing model (e.g., GPT) to interpret the player's request (e.g., prompt) and analyze the prompt for wager opportunities. The wager opportunities can include betting options derived from the player's request and the player attributes. At STEP 314, the data processing system can provide the output message to the client device in response to the request.

Various operations described herein can be implemented on computer systems. FIG. 4 shows a simplified block diagram of a representative server system 400, client computer system 414, and network 426 usable to implement certain implementations of the present disclosure. In various implementations, server system 400 or similar systems can implement services or servers described herein or portions thereof. Client computer system 414 or similar systems can implement clients described herein. The system (e.g., the data processing system 105A) and others described herein can be similar to the server system 400.

Server system 400 can have a modular design that incorporates a number of modules 402; while two modules 402 are shown, any number can be provided. Each module 402 can include processing unit(s) 404 and local storage 406.

Processing unit(s) 404 can include a single processor, which can have one or more cores, or multiple processors. In some implementations, processing unit(s) 404 can include a general-purpose primary processor as well as one or more special-purpose co-processors such as graphics processors, digital signal processors, or the like. In some implementations, some or all processing units 404 can be implemented using customized circuits, such as application specific integrated circuits (ASICs) or field programmable gate arrays (FPGAs). In some implementations, such integrated circuits execute instructions that are stored on the circuit itself. In other implementations, processing unit(s) 404 can execute instructions stored in local storage 406. Any type of processors in any combination can be included in processing unit(s) 404.

Local storage 406 can include volatile storage media (e.g., DRAM, SRAM, SDRAM, or the like) and/or non-volatile storage media (e.g., magnetic or optical disk, flash memory, or the like). Storage media incorporated in local storage 406 can be fixed, removable or upgradeable as desired. Local storage 406 can be physically or logically divided into various subunits such as a system memory, a read-only memory (ROM), and a permanent storage device. The system memory can be a read-and-write memory device or a volatile read-and-write memory, such as dynamic random-access memory. The system memory can store some or all of the instructions and data that processing unit(s) 404 need at runtime. The ROM can store static data and instructions that are needed by processing unit(s) 404. The permanent storage device can be a non-volatile read-and-write memory device that can store instructions and data even when module 402 is powered down. The term “storage medium” as used herein includes any medium in which data can be stored indefinitely (subject to overwriting, electrical disturbance, power loss, or the like) and does not include carrier waves and transitory electronic signals propagating wirelessly or over wired connections.

In some implementations, local storage 406 can store one or more software programs to be executed by processing unit(s) 404, such as an operating system and/or programs implementing various server functions such as functions of the data processing systems 105.

“Software” refers generally to sequences of instructions that, when executed by processing unit(s) 404 cause server system 400 (or portions thereof) to perform various operations, thus defining one or more specific machine implementations that execute and perform the operations of the software programs. The instructions can be stored as firmware residing in read-only memory and/or program code stored in non-volatile storage media that can be read into volatile working memory for execution by processing unit(s) 404. Software can be implemented as a single program or a collection of separate programs or program modules that interact as desired. From local storage 406 (or non-local storage described below), processing unit(s) 404 can retrieve program instructions to execute and data to process in order to execute various operations described above.

In some server systems 400, multiple modules 402 can be interconnected via a bus or other interconnect 408, forming a local area network that supports communication between modules 402 and other components of server system 400. Interconnect 408 can be implemented using various technologies including server racks, hubs, routers, etc.

A wide area network (WAN) interface 410 can provide data communication capability between the local area network (interconnect 408) and the network 426, such as the Internet. Technologies can be used, including wired (e.g., Ethernet, IEEE 802.3 standards) and/or wireless technologies (e.g., Wi-Fi, IEEE 802.11 standards).

In some implementations, local storage 406 is intended to provide working memory for processing unit(s) 404, providing fast access to programs and/or data to be processed while reducing traffic on interconnect 408. Storage for larger quantities of data can be provided on the local area network by one or more mass storage subsystems 412 that can be connected to interconnect 408. Mass storage subsystem 412 can be based on magnetic, optical, semiconductor, or other data storage media. Direct attached storage, storage area networks, network-attached storage, and the like can be used. Any data stores or other collections of data described herein as being produced, consumed, or maintained by a service or server can be stored in mass storage subsystem 412. In some implementations, additional data storage resources may be accessible via WAN interface 410 (potentially with increased latency).

Server system 400 can operate in response to requests received via WAN interface 410. For example, one of modules 402 can implement a supervisory function and assign discrete tasks to other modules 402 in response to received requests. Work allocation techniques can be used. As requests are processed, results can be returned to the requester via WAN interface 410. Such operation can generally be automated. Further, in some implementations, WAN interface 410 can connect multiple server systems 400 to each other, providing scalable systems capable of managing high volumes of activity. Techniques for managing server systems and server farms (collections of server systems that cooperate) can be used, including dynamic resource allocation and reallocation.

Server system 400 can interact with various user-owned or user-operated devices via a wide-area network such as the Internet. An example of a user-operated device is shown in FIG. 4 as client computing system 414. Client computing system 414 can be implemented, for example, as a consumer device such as a smartphone, other mobile phone, tablet computer, wearable computing device (e.g., smart watch, eyeglasses), desktop computer, laptop computer, and so on.

For example, client computing system 414 can communicate via WAN interface 410. Client computing system 414 can include computer components such as processing unit(s) 416, storage device 418, network interface 420, user input device 422, and user output device 424. Client computing system 414 can be a computing device implemented in a variety of form factors, such as a desktop computer, laptop computer, tablet computer, smartphone, other mobile computing device, wearable computing device, or the like.

Processor 416 and storage device 418 can be similar to processing unit(s) 404 and local storage 406 described above. Suitable devices can be selected based on the demands to be placed on client computing system 414; for example, client computing system 414 can be implemented as a “thin” client with limited processing capability or as a high-powered computing device. Client computing system 414 can be provisioned with program code executable by processing unit(s) 416 to enable various interactions with server system 400 of a message management service such as accessing messages, performing actions on messages, and other interactions described above. Some client computing systems 414 can also interact with a messaging service independently of the message management service.

Network interface 420 can provide a connection to the network 426, such as a wide area network (e.g., the Internet) to which WAN interface 410 of server system 400 is also connected. In various implementations, network interface 420 can include a wired interface (e.g., Ethernet) and/or a wireless interface implementing various RF data communication standards such as Wi-Fi, Bluetooth, or cellular data network standards (e.g., 3G, 4G, LTE, etc.).

User input device 422 can include any device (or devices) via which a user can provide signals to client computing system 414; client computing system 414 can interpret the signals as indicative of particular user requests or information. In various implementations, user input device 422 can include any or all of a keyboard, touch pad, touch screen, mouse or other pointing device, scroll wheel, click wheel, dial, button, switch, keypad, microphone, and so on.

User output device 424 can include any device via which client computing system 414 can provide information to a user. For example, user output device 424 can include a display to display images generated by or delivered to client computing system 414. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). Some implementations can include a device such as a touchscreen that function as both input and output device. In some implementations, other user output devices 424 can be provided in addition to or instead of a display. Examples include indicator lights, speakers, tactile “display” devices, printers, and so on.

Some implementations include electronic components, such as microprocessors, storage and memory that store computer program instructions in a computer readable storage medium. Many of the features described in this specification can be implemented as processes that are specified as a set of program instructions encoded on a computer readable storage medium. When these program instructions are executed by one or more processing units, they cause the processing unit(s) to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processing unit(s) 404 and 416 can provide various functionality for server system 400 and client computing system 414, including any of the functionality described herein as being performed by a server or client, or other functionality associated with message management services.

It will be appreciated that server system 400 and client computing system 414 are illustrative and that variations and modifications are possible. Computer systems used in connection with implementations of the present disclosure can have other capabilities not specifically described here. Further, while server system 400 and client computing system 414 are described with reference to particular blocks, it is to be understood that these blocks are defined for convenience of description and are not intended to imply a particular physical arrangement of component parts. For instance, different blocks can be but need not be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, e.g., one or more components of computer program instructions, encoded on computer storage medium for execution by, or to control the operation of, data processing apparatus. The program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of these. Moreover, while a computer storage medium is not a propagated signal, a computer storage medium can include a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The terms “data processing apparatus”, “data processing system”, “client device”, “computing platform”, “computing device”, or “device” encompasses all kinds of apparatus, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of these. The apparatus and execution environment can realize various different computing model infrastructures, such as web services, distributed computing, and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA or an ASIC.

Processors suitable for the execution of a computer program include, by way of example, both general and special purpose microprocessors, and any one or more processors of any kind of digital computer. Generally, a processor can receive instructions and data from a read-only memory or a random access memory or both. The elements of a computer include a processor for performing actions in accordance with instructions and one or more memory devices for storing instructions and data. Generally, a computer can also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), for example. Devices suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a player, implementations of the subject matter described in this specification can be implemented on a computer having a display device, e.g., a CRT (cathode ray tube), plasma, or LCD (liquid crystal display) monitor, for displaying information to the player and a keyboard and a pointing device, e.g., a mouse or a trackball, by which the player can provide input to the computer. Other kinds of devices can be used to provide for interaction with a player as well; for example, feedback provided to the player can include any form of sensory feedback, e.g., visual feedback, auditory feedback, or tactile feedback; and input from the player can be received in any form, including acoustic, speech, or tactile input. In addition, a computer can interact with a player by sending documents to and receiving documents from a device that is used by the player; for example, by sending web pages to a web browser on a player's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a player can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system such as the gaming system described herein can include clients and servers. For example, the gaming system can include one or more servers in one or more data centers or server farms. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving input from a player interacting with the client device). Data generated at the client device (e.g., a result of an interaction, computation, or any other event or computation) can be received from the client device at the server, and vice-versa.

While this specification contains many specific implementation details, these should not be construed as limitations on the scope of any inventions or of what may be claimed, but rather as descriptions of features specific to particular implementations of the systems and methods described herein. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In addition, the processes depicted in the accompanying figures do not necessarily require the particular order shown, or sequential order, to achieve desirable results.

In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. For example, the gaming system could be a single module, a logic device having one or more processing modules, one or more servers, or part of a search engine.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed only in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations, elements, or acts of the systems and methods herein referred to in the singular may also embrace implementations including a plurality of these elements; and any references in plural to any implementation, element, or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation, and references to “an implementation,” “some implementations,” “an alternate implementation,” “various implementation,” “one implementation,” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description, or any claim are followed by reference signs, the reference signs have been included for the sole purpose of increasing the intelligibility of the drawings, detailed description, and claims. Accordingly, neither the reference signs nor their absence has any limiting effect on the scope of any claim elements.

The systems and methods described herein may be embodied in other specific forms without departing from their characteristics thereof. The systems and methods described herein may be applied to other environments. The foregoing implementations are illustrative, rather than limiting, of the described systems and methods. The scope of the systems and methods described herein may thus be indicated by the appended claims, rather than the foregoing description, and changes that come within the meaning and range of equivalency of the claims are embraced therein.

What is claimed is:

1. A system, comprising:
one or more processors coupled to non-transitory memory, the one or more processors configured to:
maintain a plurality of player profiles, each player profile of the plurality of player profiles comprising a data structure identifying a plurality of player attributes;
maintain a plurality of wager opportunities corresponding to a plurality of live events;
extract, from a plurality of communication sessions identifying a first player profile of the plurality of player profiles, text data satisfying one or more extraction criteria;
update the plurality of player attributes of the first player profile using the text data;
receive, from a client device associated with the first player profile, a prompt comprising a request for a wager recommendation;
generate, using a language model and the prompt, an output message identifying at least one wager opportunity of the plurality of wager opportunities selected based on the plurality of player attributes of the first player profile; and
provide the output message to the client device in response to the request.

2. The system of claim 1, wherein the one or more processors are further configured to:
preprocess the text data to remove one or more words, phrases, or symbols.

3. The system of claim 1, wherein the one or more processors are further configured to:
extract one or more keywords from the text data extracted from the plurality of communication sessions; and
update the plurality of player attributes of the first player profile based on the one or more keywords.

4. The system of claim 3, wherein the one or more processors are further configured to:
determine a semantic score for the one or more keywords; and
update the plurality of player attributes of the first player profile based on the semantic score determined for each the one or more keywords.

5. The system of claim 3, wherein the one or more processors are further configured to:
extract the one or more keywords from the text data based on a named-entity recognition process.

6. The system of claim 1, wherein the one or more processors are further configured to:
generate an input context for the language model using the plurality of player attributes, the prompt, and the at least one wager opportunity.

7. The system of claim 1, wherein the one or more processors are further configured to:
select the at least one wager opportunity based on a similarity between data of the at least one wager opportunity and the plurality of player attributes.

8. The system of claim 1, wherein the plurality of player attributes comprise an indication of a wager type of a plurality of wager types.

9. The system of claim 1, wherein the plurality of player attributes comprise an indication of one or more participants or one or more teams corresponding to one or more live events.

10. The system of claim 1, wherein the plurality of player attributes comprise an indication of one or more types of live events.

11. A method, comprising:
maintaining, by one or more processors coupled to non-transitory memory, a plurality of player profiles, each player profile of the plurality of player profiles comprising a data structure identifying a plurality of player attributes;
maintaining, by the one or more processors, a plurality of wager opportunities corresponding to a plurality of live events;
extracting, by the one or more processors, from a plurality of communication sessions identifying a first player profile of the plurality of player profiles, text data satisfying one or more extraction criteria;
updating, by the one or more processors, the plurality of player attributes of the first player profile using the text data;
receiving, by the one or more processors, from a client device associated with the first player profile, a prompt comprising a request for a wager recommendation;
generating, by the one or more processors, using a language model and the prompt, an output message identifying at least one wager opportunity of the plurality of wager opportunities selected based on the plurality of player attributes of the first player profile; and
providing, by the one or more processors, the output message to the client device in response to the request.

12. The method of claim 11, further comprising:
preprocessing, by the one or more processors, the text data to remove one or more words, phrases, or symbols.

13. The method of claim 11, further comprising:
extracting, by the one or more processors, one or more keywords from the text data extracted from the plurality of communication sessions; and
updating, by the one or more processors, the plurality of player attributes of the first player profile based on the one or more keywords.

14. The method of claim 13, further comprising:
determining, by the one or more processors, a semantic score for the one or more keywords; and
updating, by the one or more processors, the plurality of player attributes of the first player profile based on the semantic score determined for each the one or more keywords.

15. The method of claim 13, further comprising:
extracting, by the one or more processors, the one or more keywords from the text data based on a named-entity recognition process.

16. The method of claim 11, further comprising:
generating, by the one or more processors, an input context for the language model using the plurality of player attributes, the prompt, and the at least one wager opportunity.

17. The method of claim 11, further comprising:
selecting, by the one or more processors, the at least one wager opportunity based on a similarity between data of the at least one wager opportunity and the plurality of player attributes.

18. The method of claim 11, wherein the plurality of player attributes comprise an indication of a wager type of a plurality of wager types.

19. The method of claim 11, wherein the plurality of player attributes comprise an indication of one or more participants or one or more teams corresponding to one or more live events.

20. The method of claim 11, wherein the plurality of player attributes comprise an indication of one or more types of live events.
